(19) United States
(12) Patent Application Publication
(10) Pub. No.: US 2006/0171158 A1
(43) Pub. Date: Aug. 3, 2006

(54) Vehicle headlamp

(76) Inventors: Josephus Christiaan Maria Hendricx, Eindhoven (NL); Christoffel Wijenberg, Eindhoven (NL); Johannes Petrus Maria Ansems, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/536,812

(22) PCT Filed: Nov. 6, 2003
(86) PCT No.: PCT/IB03/50016

§ 371 Date: May 27, 2005

(30) Foreign Application Priority Data
Dec. 2, 2002 (EP) 02080025.6

(51) Int. Cl. F21V 1/00

(52) U.S. Cl. 362/509

(57) ABSTRACT

Vehicle headlamp with a metal halide lamp comprising: a discharge vessel surrounded with clearance by an outer envelope and having a ceramic wall which encloses a discharge space containing Xenon (Xe) and an ionizable filling; a first and a second current conductor entering the discharge vessel and each supporting an electrode in the discharge vessel, wherein the first and the second current conductor each extend from a ceramic sealing compound sealing the discharge vessel around the current conductors in a gastight manner to the exterior of the discharge vessel, and wherein the discharge vessel has extended end parts in each of which a respective current conductor is enclosed, which plugs each have a free end where the discharge vessel is sealed by the ceramic sealing compound; with the special feature that said vehicle headlamp has a lightreflective coating surrounding at least a portion of at least one of the end parts.

The present invention relates to a vehicle headlamp with a metal halide lamp comprising:

a discharge vessel surrounded with clearance by an outer envelope and having a ceramic wall which encloses a discharge space containing Xenon (Xe) and an ionizable filling;

a first and a second current conductor entering the discharge vessel and each supporting an electrode in the discharge vessel, wherein the first and the second current conductor each extend from a ceramic sealing compound sealing the discharge vessel around the current conductors in a gastight manner to the exterior of the discharge vessel, and wherein the discharge vessel has extended end parts in each of which a respective current conductor is enclosed, which end parts each have a free end where the discharge vessel is sealed by the ceramic sealing compound.

The invention also relates to a metal halide lamp to be used in the present headlamp.

Such a lamp is known from international ACT) patent publication no. WO 00/67294 in the name of the same Applicant. This known electric discharge lamp has a tubular, light-transmissive ceramic lamp vessel, for example of polycrystalline aluminum oxide, and a first and a second current conductor which enter the lamp vessel opposite to each other and each support an electrode in the lamp vessel, for example a tungsten electrode which is welded to the current conductors. The second current conductor has a return portion extending along an outside of the outer envelope made of quartz. The ceramic sealing compound provided in a melting process seals the lamp around the current conductors in a gastight manner. The lamp vessel has an ionizable filling comprising xenon as a rare gas, sometimes mercury, and metal halides. The abovementioned specific dimensions of the discharge vessel of the known lamp ensure a very compact and lightweight lamp.

A disadvantage of the vehicle headlamp described in the cited international (PCT-) patent publication is the following. As the sealing compound is sensitive to high (operating) temperatures of the vehicle lamp, the sealing compound is applied as remote as possible from a central portion of the discharge vessel. However, the elongated end parts or extended plugs function as cooling fins negatively influencing an operating temperature in the discharge vessel. As a consequence thereof part of the ionizable filling may condense at the location of the end parts, with all negative consequences involved.

It is an object of the present invention to provide a vehicle headlamp of the type described in the introduction of the description with which the above disadvantages are obviated. In order to achieve this object, such a headlamp is characterized in that said vehicle headlamp has a light-reflective coating surrounding at least a portion of at least one of the end parts, preferably a portion of both end parts adjacent a central part of the discharge vessel. This reflective coating, which is resistant to high (operating) temperatures in the vehicle headlamp, reflects transmitted light (radiation) back into the discharge vessel in order to increase the temperature in the discharge vessel, so that the temperature of liquid salts is increased and thus the partial pressure of the metal halides is increased. The present vehicle headlamp therefore, has a better efficacy. The reflective coating also serves to shield a reflector of the headlamp against disturbing light coming from an area behind tips of the electrodes. Particularly, the light-reflective coating is provided on the outer side of the ceramic wall of at least a portion of the end parts, while in a preferred embodiment the light-reflective coating is band-shaped. It is noted that the term “light-reflective” used here refers to reflection of light in the entire spectrum and not only of visible light.

The present invention is based on the recognition that the reflective coating, preferably in the form of a band entirely surrounding (i) a portion of both end parts adjacent a central (middle) part of the discharge vessel, (ii) both ends of said central part can influence the operating temperature in the discharge vessel, thus maintaining (increasing or generally “controlling”) the ionizable filling in a vapor phase. The light emission coefficient of the reflective coating should preferably be lower than the light emission coefficient of the ceramic wall of the discharge vessel in order to increase an end temperature of the discharge vessel.

In a preferred embodiment of a vehicle headlamp according to the invention, the light-reflective coating is provided on the inner side of the outer envelope. Alternatively, the light-reflective coating is provided on the outer side of the outer envelope.

In another preferred embodiment of a vehicle headlamp according to the invention, a line through a tip of an electrode and an edge of the lightreflective coating directed towards the discharge vessel encloses an angle varying between 5° and 30° with a plane perpendicular to said electrode.

In another preferred embodiment of a vehicle headlamp according to the invention, the discharge vessel has a circumferential clearance inside the outer envelope of at most 5 mm.

It is noted that the present invention is not restricted to the use of mercury (Hg) as part of the ionizable filling of the metal halide lamp; a mercury-free filling may also be used in the said lamp.

The above and further aspects of the headlamp in accordance with the invention will now be explained with reference to a drawing (not true to scale), in which

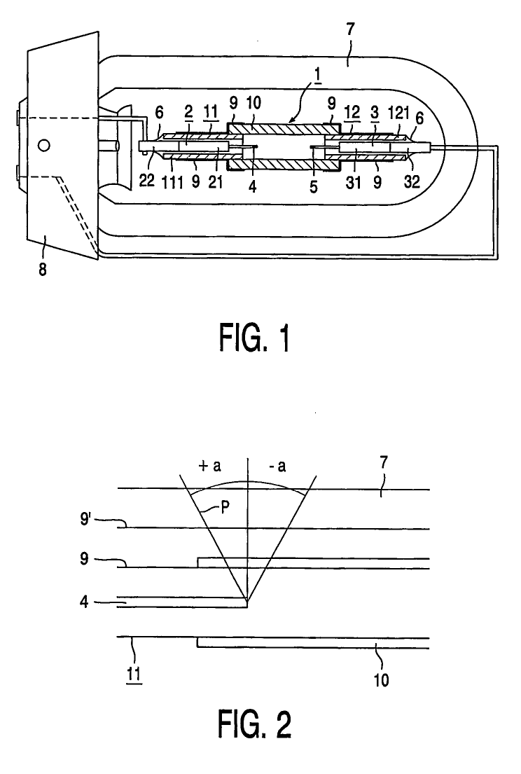

FIG. 1 shows an embodiment in a side elevation, and

FIG. 2 shows a cross-section of a detail of FIG. 1.

In FIG. 1, the electric discharge lamp has a tubular, light-transmissive ceramic discharge vessel, of polycrystalline aluminum oxide in the Figure, and a first and a second current conductor 2, 3 which enter the discharge vessel 1 opposite each other and each support an electrode 4,5 in the discharge vessel 1, i.e a tungsten electrode which is welded to the current conductors 2,3. in the Figure. A ceramic sealing compound 6, 30% by weight of aluminum oxide, 40% by weight of silicon oxide and 30% by weight of dysprosium oxide in the figure, provided in a melting process seals the discharge vessel 1 around the current conductors 2, 3 in a gastight manner. The discharge vessel has an ionizable filling comprising xenon as a rare gas and a metal halide. A mixture of sodium and praseodymium iodide and dysprosium iodide is used as a metal halide. The xenon gas pressure inside the discharge vessel exceeds 8 bar (under room temperature conditions).

The first current conductor 2 has a first halide-resistant part 21 within the discharge vessel 1 and, extending from the ceramic sealing compound 6 to the exterior of the discharge vessel 1, a second part 22 which is welded to the first part 21.

The first part 21 of the first current conductor 2 consists of a material chosen from tungsten silicide, molybdenum aluminide, molybdenum boride, pentamolybdenum trisilicide, and combinations of at least of two of these materials, for example. Alternatively, Mo—Al₂O₃ is used.

In the lamp shown, the second current conductor 3 has a similar first part 31 and second part 32 as the first current conductor 2. The second part 22, 32 of each of the two current conductors 2, 3 consists of niobium, the first part 21, 31 of each of the two consists of tungsten silicide, for example, W₅Si₃.

The discharge vessel 1 has narrow end parts or plugs 11, 12 in which respective current conductors 2, 3 are enclosed. The end parts or plugs 11, 12 have free ends 111, 121, where the lamp vessel 1 is sealed by the ceramic sealing compound 6. The central part 10 of the discharge vessel 1 is connected to the end parts or plugs 11,12 by means of sintering.

The second part 22, 32 of each current conductor is entirely incorporated in the ceramic sealing compound 6 with the discharge vessel 1.

In FIG. 1, the discharge vessel 1 is enveloped by an outer envelope 7 which is sealed in a gastight manner and is evacuated or filled with an inert gas in order to protect the niobium second parts 22, 32 of the current conductors 2, 3. The outer envelope 7 supports a lamp cap 8. In another embodiment, the outer envelope 7 may be provided with two lamp caps, for example R7 lamp caps.

FIG. 2 shows a band-shaped light-reflective coating 9 provided on the outer side of a portion of the end parts or plugs 11,12 adjacent the central part 10 of the discharge vessel 1, and provided on both ends of the central part 10 of the discharge vessel 1. Alternatively, the light-reflective coating 9′ is on the inner side of the outer envelope 7. A line P through a tip of the electrode 4 and an edge of the light-reflective coating 9 or 9′ directed towards the discharge vessel 1 encloses an angle α varying between 5° and 30° with a plane perpendicular to said electrode 4. Said band-shaped light-reflective coating 9 or 9′ may have a profiled shape, such as corrugated, i.e. in waves, and may be of gold or platinum.

The distance EA between the tips of the electrodes 4,5 is 5 mm, the internal diameter Di is 1.2 mm, so that the ratio EA/Di=4.16.

1. Vehicle headlamp with a metal halide lamp comprising:
a discharge vessel surrounded with clearance by an outer envelope and having a ceramic wall which encloses a discharge space containing Xenon (Xe) and an ionizable filling;
a first and a second current conductor entering the discharge vessel and each supporting an electrode in the discharge vessel, wherein the first and the second current conductor each extend from a ceramic sealing compound sealing the discharge vessel around the current conductors in a gastight manner to the exterior of the discharge vessel, and wherein the discharge vessel has extended end parts in each of which a respective current conductor is enclosed, which end parts each have a free end where the discharge vessel is sealed by the ceramic sealing compound,
characterized in that said vehicle headlamp has a light-reflective coating surrounding at least a portion of at least one of the end parts.

2. Vehicle headlamp according to claim 1, wherein the light-reflective coating is provided on the outer side of the ceramic wall of at least a portion of the end parts.

3. Vehicle headlamp according to claim 2, wherein the light-reflective coating is band-shaped and surrounds a portion of both end parts adjacent a central part of the discharge vessel, as well as both ends of said central part.

4. Vehicle headlamp according to claim 1, wherein the light-reflective coating is provided on the inner side of the outer envelope.

5. Vehicle headlamp according to claim 3 or 4, wherein a line through a tip of an electrode and an edge of the light-reflective coating directed towards the discharge vessel encloses an angle varying between 5° and 30° with a plane perpendicular to said electrode.

6. Vehicle headlamp according to claim 1, wherein the light-reflective coating is provided on the outer side of the outer envelope.

7. Vehicle headlamp according to any of the preceding claims 1 through 6, wherein the discharge vessel has a circumferential clearance inside the outer envelope of at most 5 mm.

8. Vehicle headlamp according to any of the preceding claims 1 through 7, wherein tips of the electrodes have a mutual interspacing EA so as to define a discharge path between them, wherein the discharge vessel has an internal diameter Di at least over the distance EA, and wherein Di is smaller than or equal to 2.0 mm, particularly smaller than or equal to 1.5 mm, particularly smaller than or equal to 1.0 mm.

9. Vehicle headlamp according to any of the preceding claims 1 through 8, wherein the end parts have an average internal diameter Di′ smaller than or equal to 0.6 mm.

10. Vehicle headlamp according to any of the preceding claims 1 through 9, wherein the light-reflective coating comprises a material chosen from the group of Cu, Ag, Rh, Au, W, Mo, Pt, Nb, Ta, Ni, Re, Cr, Fe, Ti, U, Al, and Ir.
